(19) United States
(12) Patent Application Publication
(10) Pub. No.: US 2008/0090608 A1
(43) Pub. Date: Apr. 17, 2008

(54) MOBILE COMMUNICATION TERMINAL FOR MP3

(75) Inventors: Joon-Suh KIM, Anyang-si (KR); Yeo-Jin Moon, Gwangju-si (KR); Chang-Soo Lee, Bupyeong-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/859,552

(22) Filed: Sep. 21, 2007

(30) Foreign Application Priority Data
Sep. 21, 2006 (KR) 91720-2006

(51) Int. Cl. H04M 1/02

(52) U.S. Cl. 455/556.1; 700/94

(57) ABSTRACT

A mobile communication terminal for Moving Picture Experts Group Layer 3 (MP3). The mobile communication terminal is provided with a plurality of keys and at least one MP3-dedicated key.

### PRIORITY

This application claims priority under 35 U.S.C. § 119(a) to an application filed in the Korean Industrial Property Office on Sep. 21, 2006 and assigned Serial No. 2006-91720, the contents of which are hereby incorporated by reference.

### BACKGROUND OF THE INVENTION

1. Field of the Invention

The present invention generally relates to a mobile communication terminal, such as a Digital Multimedia Broadcasting (DMB) phone, a game phone, a chatting phone, a camera phone, an MP3 phone, a cellular phone, a Personal Communication System (PCS), a Personal Digital Assistant (PDA), a Hand Held Phone (HHP), etc., and in particular, to a mobile communication terminal for Moving Picture Experts Group Layer 3 (MP3), which is convenient to use in the MP3 mode.

2. Description of the Related Art

A mobile communication terminal, as used herein, refers to an appliance for use in wireless communication with a counterpart while being carried by a user. For example, wireless communication includes voice communication, message transmission, file transmission, image communication, camera function, or the like. In addition, such a mobile communication terminal may also serve as a private secretary for managing phone numbers, private schedules, or the like.

Considering convenient portability, mobile communication terminals are continually becoming more miniaturized, slimmed, light-weighted and adapted to be conveniently gripped and developed toward multimedia appliances capable of implementing more various service functions, for which contents for entertainment including games, recreation, MP3, etc. are regarded as important.

A conventional mobile communication terminal may be classified into a bar-type or a folder-type according to the appearance thereof, considering portability, convenience of use, etc.

A bar-type mobile communication terminal is an appliance with a single housing formed in a bar-type including a display unit, a key pad unit, an antenna device, a receiver unit, a transceiver, etc on its front face. The keypad unit includes 3×4 keys.

A folder-type mobile communication terminal is an appliance with a folder rotatably connected to a bar-type housing via a hinge device in such a manner that the folder is capable of being folded onto the housing. For example, since such a folder-type mobile communication terminal is configured in such a manner that a folder is rotatably connected to a main body via a hinge, in which a key pad unit having 3×4 keys is arranged on the main body and a display is arranged on the folder, which is advantageous in miniaturization and portability of the mobile communication terminal. An example of such a mobile communication terminal is disclosed in U.S. Pat. No. 6,865,406, which is assigned to the assignee of the present application, and the contents of which are incorporated herein by reference.

In addition, a conventional mobile communication terminal may be classified into a swing-type or a sliding-type.

A conventional swing-type mobile communication terminal is an appliance with two housings assembled to be opposed to each other, in which one of the two housings is capable of swinging in relation to the other, while being continuously opposed to each other so that the front face of the other housing is opened or closed. The housing capable of swinging is provided with a display unit on the front face thereof, and the other housing is provided with a keypad unit including 3×4 keys on the front face thereof. An example of such a swing-type mobile communication terminal is disclosed in detail in U.S. Pat. No. 7,158,37, which is assigned to the assignee of the present application, and the contents of which are incorporated herein by reference.

A conventional sliding-type mobile communication terminal means an appliance with two housings assembled to be opposed to each other, in which one of the two housings is longitudinally slidable so that the front face of the other housing is opened or closed. The slidable housing is provided with a display unit and the other housing is provided with a keypad unit including 3×4 keys. An example of such a sliding-type mobile communication terminal is disclosed in detail in U.S. patent application Publication Ser. No. 10/379,551, the contents of which are incorporated herein by reference, in which a key pad unit including 3×4 keys is positioned on a main housing and a display unit is provided on a sliding housing.

Some mobile communication terminals may be worn at a certain part of a user's body, for example, at a wrist, a neck, a head or ear(s) at present, or will be done so in the future.

Conventional mobile communication terminals do not have a problem of inconvenience in inputting data or confirming displayed data in the phone mode for voice communication or text message transmission. However, under the circumstance in which the mobile communication terminals are made to be adapted to multimedia, for example, in the MP3 mode, there are problems in using the conventional mobile communication terminals.

At present, mobile communication terminals are developed to have various convergenced functions. As a result, a camera function, an MP3 function, a TV function, an internet function, or the like is frequently provided in mobile communication terminals.

However, in conventional mobile communication terminals, since a key for use in the MP3 mode is positioned at a distance from or adjacent to 3×4 keys which are most frequently used, it is required to carefully operate the key for use in the MP3 mode, which causes inconvenience.

Substantially all the types of conventional mobile communication terminals are configured to be operated in the UI (user interface) environment so that they can be most conveniently used in the phone mode. However, the UI environment is extremely inferior for certain modes, as well as the MP3 mode, from a standpoint of convenience.

### SUMMARY OF THE INVENTION

Accordingly, the present invention substantially solves the above-mentioned problems occurring in the prior art, and provides a mobile communication terminal which is convenient to use in the MP3 mode as well as in the phone mode.

An aspect of the present invention is to provide a mobile communication terminal, the operation of which can be conveniently performed in the MP3 mode.

Another aspect of the present invention is to provide a mobile communication terminal, in which an MP3-dedicated key, which can be tactually or visually differentiated from 3×4 keys, is positioned so that the key operation can be conveniently performed in the MP3 mode.

In accordance with an aspect of the invention, there is provided a mobile communication terminal including a plurality of keys and at least one Moving Picture Experts Group Layer 3 (MP3)-dedicated key.

In accordance with another aspect of the invention, the at least one MP3-dedicated key can project a particular height above the plurality of keys, have a color different from that of the plurality of keys, have a material different from that of the plurality of keys, provide tactual differentiation from that of the plurality of keys, provide visual differentiation from that of the plurality of keys, be arranged at a center of a key array, be arranged horizontally.

In accordance with another aspect of the invention, a call key, an end key and at least one 4-way key can be arranged around the plurality of keys, so as to surround the plurality of keys, wherein the plurality of keys can be configured as an array of 3×4 keys, and the array of 3×4 keys can include numeral keys, character keys, a * key, and a # key, at least one four-way key, and an end key.

### BRIEF DESCRIPTION OF THE DRAWINGS

The above and other aspects, features and advantages of the present invention will be more apparent from the following detailed description taken in conjunction with the accompanying drawings, in which:

FIG. 1 is a front side perspective view showing a mobile communication terminal according to an embodiment of the present invention;

FIG. 2 is a front elevational view corresponding to FIG. 1;

FIG. 3 is a rear side perspective view of the mobile communication terminal of FIG. 1; and

FIG. 4 is a rear elevational view corresponding to FIG. 3.

### DETAILED DESCRIPTION OF THE PREFERRED EMBODIMENTS

Preferred embodiments of the present invention are described below with reference to the accompanying drawings. In the following description, the same elements will be designated by the same reference numerals although they are shown in different drawings.

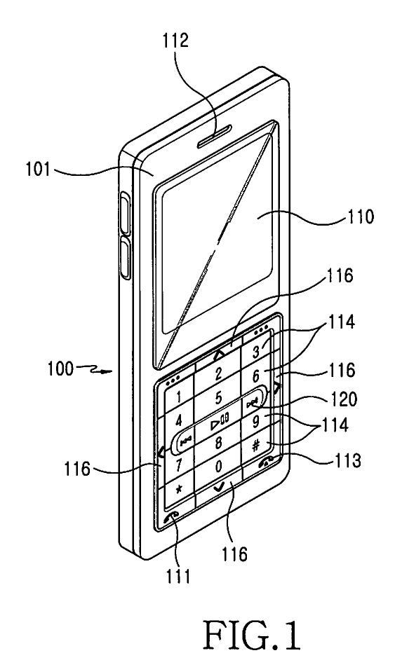

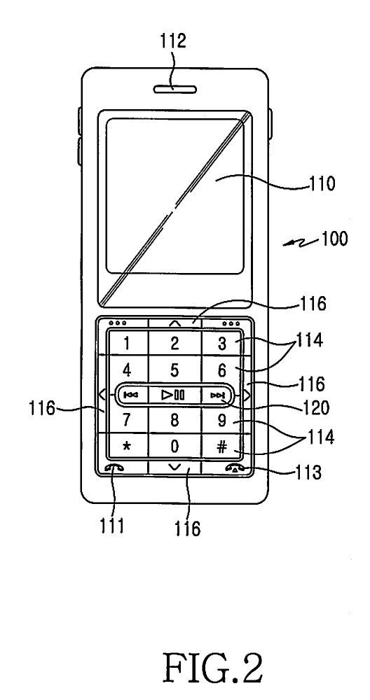

The mobile communication terminal shown in FIGS. 1 and 2 is a bar-type, which can be conveniently used in a Moving Picture Experts Group Layer 3 (MP3) mode as well as in a phone mode. However, it should be appreciated that the present invention is not limited to the bar-type mobile communication terminal and can be employed all the types of mobile communication terminals.

The mobile communication terminal shown in the drawings includes a bar-type body 100, which is provided with a speaker 112, a display unit 110, and a keypad unit on the front face 101 thereof, wherein the keypad unit includes keys 111, 113, 114 and 116 related to the phone mode, and a key related to the MP3 mode. From FIGS. 1 and 2, only the top portions of the keys of the keypad unit can be seen.

The keypad unit includes a plurality of keys and at least one MP3 dedicated key. The keypad example shown in FIG. 1 includes internationally standardized 3×4 keys 114, a call key 111, an end key 113, four-way keys 116, and MP3-dedicated keys 120. According to the present invention, the MP3-dedicated keys 120 are arranged within the array of 3×4 keys. The 3×4 keys 114 include numeral keys, character keys, a * key, a # key, etc.

The MP3-dedicated keys 120 may be configured to project above the 3×4 keys to a particular height so a user can easily operate the MP3-dedicated keys 120 using their sense of touch without seeing the keypad unit.

The MP3-dedicated keys 120 may be formed from a material different from that of the 3×4 keys 114, so that the user can easily differentiate the MP3-dedicated keys 120 from the 3×4 keys 114 using their sense of touch without seeing the keypad unit, thereby easily operating the MP3-dedicated keys 120.

In addition, the MP3-dedicated keys 120 may be arranged at the center of the 3×4 keys 114, so that the user can easily differentiate the MP3-dedicated keys 120 from the 3×4 keys 114 using their sense of touch without seeing the key pad unit, thereby easily operating the MP3-dedicated keys 120.

Furthermore, the MP3-dedicated keys 120 may be formed in a color different from that of the 3×4 keys 114, so the MP-3 dedicated keys 120 are visually differentiated from the 3×4 keys, thereby allowing easy operation of the MP3-dedicated keys 120.

Preferably, the MP-3 dedicated keys 120 include three keys arranged at the center of the 3×4 keys.

In the inventive mobile communication terminal, the MP3-dedicated keys 120 are arranged at the center of the 3×4 keys 114, and the call key 111, the end key 113, and the 4-way keys 116 including four keys are arranged around the 3×4 keys. Therefore, the call key 111, the end key 113, and the four keys of the 4-way keys 116 surround the 3×4 keys.

It is also possible to configure the key pad unit in such a manner that the 3×4 keys 114, the call key 111, the end key 113, and the four keys 116 emit light in the phone mode, while the MP3-dedicated keys 120 emit light in the MP3 mode, whereby the MP3-dedicated keys 120 can be visually differentiated from the surrounding keys in the MP3 mode.

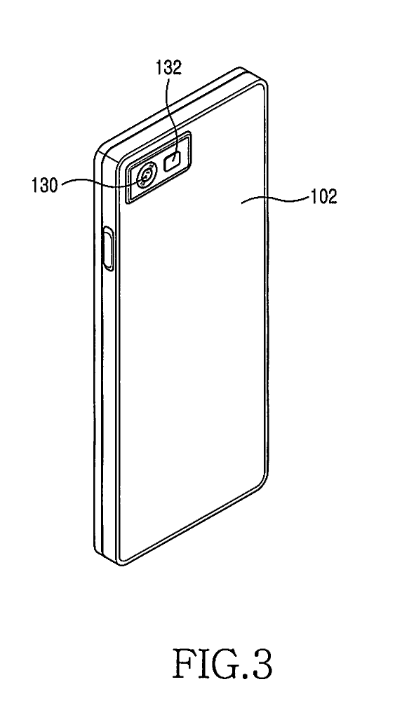

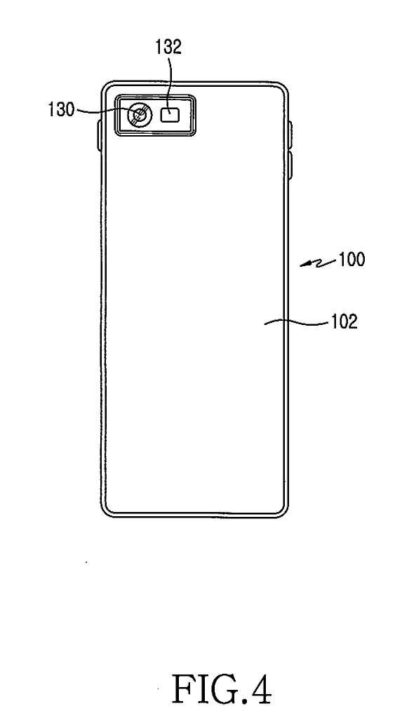

As shown in FIGS. 3 and 4, a camera lens and an illumination apparatus 132 are arranged at a corner area of the rear face 102 of the body.

In conclusion, the inventive mobile communication terminal has at least one more MP3-dedicated key arranged at the center or central area (an area allowing a user to conveniently press the keys) of standardized 3×4 keys, which are most frequently used, wherein the MP3-dedicated keys may project above the 3×4 keys, the MP3-dedicated keys may be formed from a material different from that of the 3×4 keys, or the MP3-dedicated keys may be formed in a color different from that of the 3×4 keys, so that the user can conveniently operate the keys in the MP3 mode. The MP3-dedicated keys provide tactual and visual differentiation from other keys on the mobile communication terminal.

As described above, the inventive mobile communication terminal is convenient to use in the MP3 mode, as well as in the phone mode. In particular, according to the present invention, the key pressing operation can be more conveniently performed in the MP3 mode. Furthermore, because the key pressing operation is capable of being conveniently performed by tactually or visually differentiating the MP3-dedicated keys from the other keys, the UI environment can be improved for the MP3 mode.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication terminal comprising a plurality of keys and at least one Moving Picture Experts Group Layer 3 (MP3)-dedicated key.

2. A mobile communication terminal according to claim 1, wherein the at least one MP3-dedicated key projects a particular height above the plurality of keys.

3. A mobile communication terminal according to claim 1, wherein the at least one MP3-dedicated key has a color different from that of the plurality of keys.

4. A mobile communication terminal according to claim 1, wherein the at least one MP3-dedicated key is of a material different from that of the plurality of keys.

5. A mobile communication terminal according to claim 1, wherein the at least one MP3-dedicated key provides tactual differentiation from that of the plurality of keys.

6. A mobile communication terminal according to claim 1, wherein the at least one MP3-dedicated key provides visual differentiation from that of the plurality of keys.

7. A mobile communication terminal according to claim 1, wherein the at least one MP3-dedicated key is arranged at a center of a key array.

8. A mobile communication terminal according to claim 1, wherein a plurality of MP3-dedicated keys are arranged horizontally.

9. A mobile communication terminal according to claim 1, wherein a call key, an end key and at least one 4-way key are arranged around the plurality of keys, so as to surround the plurality of keys.

10. A mobile communication terminal according to claim 1, wherein the plurality of keys are configured as an array of 3×4 keys.

11. A mobile communication terminal according to claim 10, wherein the array of 3×4 keys include numeral keys, character keys, a * key, and a # key.

12. A mobile communication terminal according to claim 1, wherein the plurality of keys include at least one four-way key.

13. A mobile communication terminal according to claim 1, wherein the plurality of keys include an end key.
